(19) United States
(12) Patent Application Publication
(10) Pub. No.: US 2002/0089410 A1
(43) Pub. Date: Jul. 11, 2002

(54) Biometric authentication device for use with a personal digital assistant

(76) Inventors: Martin J. Janiak, Middleton, MA (US); Cathy Schaub, Madison, WI (US); Don Lynam, Madison, WI (US); Barry Howe, Middleton, WI (US); Greg Wachter, Sun Prairie, WI (US); Greg Krueger, Jefferson, WI (US)

Correspondence Address: WHYTE HIRSCHBOECK DUDEK S C, 111 EAST WISCONSIN AVENUE, SUITE 2100, MILWAUKEE, WI, 53202

(21) Appl. No.: 09/854,078

(22) Filed: May 11, 2001

Related U.S. Application Data
(60) Provisional application No. 60/248,052, filed on Nov. 13, 2000.

(51) Int. Cl. H04Q 1/00

(52) U.S. Cl. 340/5.53; 340/5.83

(57) ABSTRACT

A biometric authentication device for use with a host having memory, processing power and communication capabilities, such as a personal digital assistant (PDA). The biometric device includes a finger print module having a fingerprint sensor for capturing a user's fingerprint placed onto the fingerprint sensor. The fingerprint module is interconnected and communicates with the host PDA. The fingerprint module also includes a portion adapted to receive and read a card containing electronic fingerprint information, such as a smart card. The fingerprint module is capable of determining a match between the user's fingerprint captured from the fingerprint sensor and the electronic fingerprint information stored on the smart card. Determination of the match between the end user (and those) captured fingerprint and the electronic fingerprint information enables biometric verification or identification of the end user. This information may be transmitted via the interconnected PDA or other wireless host device. The biometric device is useful in time and attendance, access and control as well as user identification and verification applications. Application program interface software used with the biometric device permits application specific solutions to be developed for the particular PDA or other host device.

### CROSS-REFERENCE TO RELATED APPLICATION

This application claims the benefit of U.S. Provisional Application No. 60/248,052 filed Nov. 13, 2000.

### BACKGROUND OF THE INVENTION

The present invention relates generally to biometrics and biometric solutions, and more particularly to a biometric solution that combines a personal digital assistant or other pocket type PC with a biometric system that is useful in identification, time-and-attendance and access-and-control applications.

The field of biometrics, or the measuring of a physical characteristic used to recognize the identity or verify the claimed identity of an individual, has emerged as an increasingly reliable methodology for verification (one-to-one) and identification (one-to-many) of individuals. Biometrics has become a very powerful tool in the solving of problems associated with requiring positive identification of individuals.

Live capture biometrics, which is the process of capturing a biometric sample by an interaction between an end user and a biometric system, requires a significant amount of memory, processing power and communication capabilities to quickly and accurately perform the biometric functions assigned. A high level of functionality, and correspondingly, processing power, is required to: read from and write to memory and smart cards; read fingerprint sensors; extract minutia; and compare against smart card or internally stored fingerprint data. Oftentimes, the resultant product may be prohibitively bulky, expensive and complicated so as not to be readily adapted for commercial applications, particularly for those biometric applications that require verification or identification from a variety of locations. Additionally, such devices are not readily adaptable application-to-application, and the entire unit must be reconfigured in order to run the desired biometric application.

Therefore, there exists the need for a portable biometric system that is readily connectable to and uses readily available devices having the requisite memory, processing power and communication capabilities necessary to perform the biometric function for the particular application. Additionally, there exists the need for a biometric solution that can be easily integrated into an application specific software to allow for customized applications of the fingerprint verification and identification technology.

### SUMMARY OF THE INVENTION

The present invention provides a biometric authentication device and overcomes the aforementioned problems, and provides a biometric authentication device that may be used with a personal digital assistant to yield a biometric solution.

In accordance with one aspect of the invention, a biometric device includes a fingerprint module having fingerprint sensor for reading a fingerprint and generating fingerprint data, and electronic circuitry located within the fingerprint module which is connected to the fingerprint sensor to process the fingerprint data. The fingerprint module may further include a compact flash connector for connecting the fingerprint module and a smart card slot for receiving a smart card.

In accordance with another aspect of the invention, a biometric device for use with a personal digital assistant PDA and a user of the PDA is disclosed. The biometric device includes a fingerprint module including a fingerprint sensor for reading a fingerprint of the user. The fingerprint module is receptive to and connectable with the PDA to allow electronic communication with the PDA. The fingerprint module includes a portion adapted to receive and read a data card having fingerprint information. The fingerprint module, as well as application software resident in the PDA, is capable of determining a match between the user fingerprint right from the fingerprint sensor and the fingerprint information on the data card.

In another aspect of the invention, a biometric identification module comprises a housing, and a biometric sensor exposed through the housing for obtaining user biometric data. The biometric identification module also includes a receiving portion receptive to a biometric data storage device having stored biometric data, and electronic processing and storage circuitry disposed within the housing and connected to the biometric sensor. The module also includes an application program interface programmed into the processing and storage circuitry to compare the user biometric data to the stored biometric data.

In another aspect of the invention, the biometric device includes a fingerprint module, a fingerprint sensor connected to the fingerprint module for generating fingerprint data, and a communication port integral with the fingerprint module. The communication port is in electrical communication with the fingerprint sensor for transmitting the fingerprint data from the fingerprint sensor through the communication port.

Various other features, objects and advantages of the present invention will be made apparent from the following detailed description and the drawings.

### BRIEF DESCRIPTION OF THE DRAWINGS

The drawings illustrate one mode presently contemplated for carrying out the invention.

In the drawings:

FIG. 1 is a perspective view illustrating a biometric system in accordance with the present invention;

FIG. 2 is another perspective view showing the biometric system removed from the personal digital assistant;

FIG. 3 shows a side elevational view of the present invention;

FIG. 4 is an enlarged exploded view illustrating the connection between the PDA and the present invention taken along line 4-4 of FIG. 3;

FIG. 5 is a functional diagram illustrating the functional layer of one embodiment of the present invention;

FIG. 6 is a functional diagram illustrating a process stack for various functionality for one aspect of the present invention; and

FIG. 7 is a functional block diagram illustrating the biometric solution system in accordance with one aspect of the present invention;

### DETAILED DESCRIPTION OF THE PREFERRED EMBODIMENT

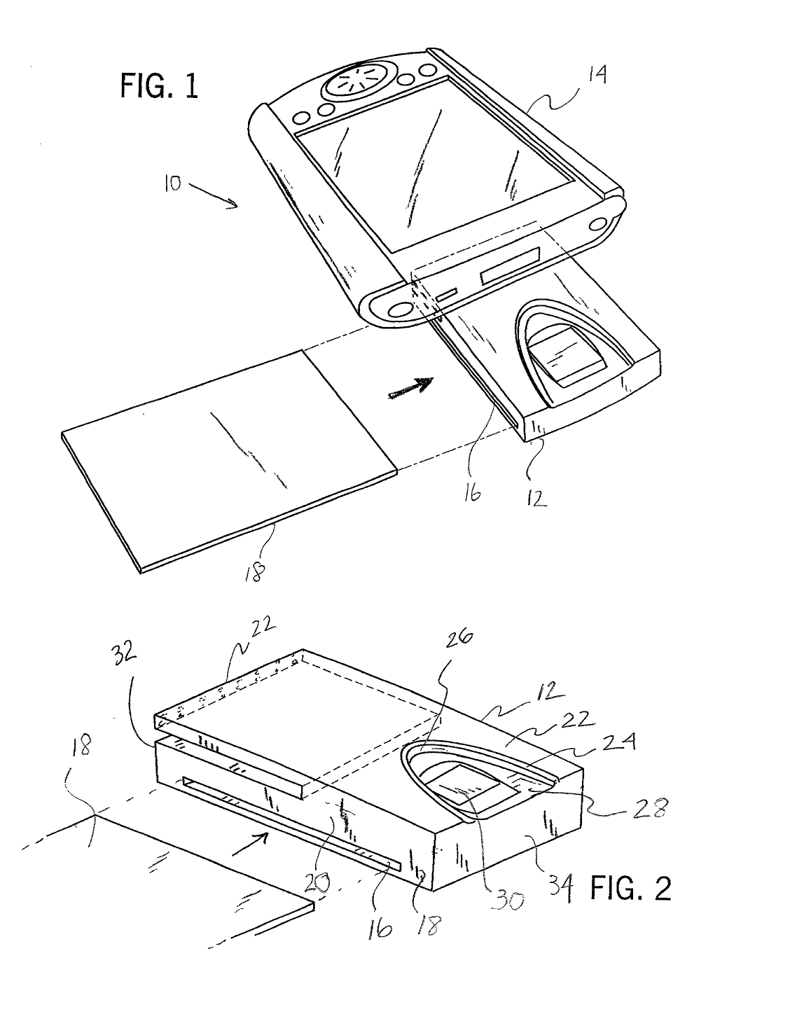

Referring now to FIG. 1, the biometric system of the present invention is shown generally by the numeral 10. The biometric system 10 includes a fingerprint identification module (FIM) 12. FIM 12 is connected to personal digital assistant (PDA) such that an electronic connection is established. The PDA as used herein includes any type of portable electronic device, including personal digital assistants (PDAs), personal pocket PCs, wireless phones having PDA capabilities, or other personal electronic devices having the requisite power and processing capabilities as contemplated by the present invention. Other biometric solutions may require other electronic personal digital assistant devices, and such devices are contemplated as being suitable for purposes of the present invention. Several PDAs which are currently available include the Compact IPAQ, the Compact Aero 1550, the HP Jornada 540, the Cassiopeia E-115 and the Casio IT-700/800. Fingerprint identification module 12 interconnects with personal digital assistant 14 to form the portable biometric reader. Preferably, the fingerprint identification module 12 connects to the PDA so as not to interfere with normal operation of the PDA. Additionally, if the PDA utilizes a cradle-type device for stability and/or synchronization purposes, the addition of the fingerprint identification module 12 does not interfere with the installation of the PDA into the cradle, or cause tipping of the cradle during operation. Fingerprint identification module 12 may be removed from the PDA when desired. Fingerprint identification module, in a preferred embodiment, includes a slot 16 for receiving a data card 18. Data card 18 may come in any form that is capable of storing fingerprint data for an enrollee. An enrollee is a potential user of the system who has gone through the enrollment process, or the process of collecting biometric samples from a person and storing the biometric samples on the data card for comparison to the end user's biometric sample. Data card 18 may be, for example, an optical card where a single (or multiple) fingerprint image(s) is/are contained within a 2D barcode symbol, such as a PDF 417 patch, or printed on a plastic ID card. This fingerprint image is capable of being optically read from the data card. Data card 18 may also include a memory card that includes a memory chip embedded within the card (chip card). The chip is capable of storing more information than with use of the optical data card, but also permits the writing of transactional data to the chip while the data card is inserted. The data can be downloaded later to another central location for the particular application. The data can then be erased from the memory card, thereby freeing up space for additional information storage. Additionally, the data card may be a smart card, where transactional data can be collected and stored, but it also may be processed and used directly by the smart card, in particular applications. Therefore, a card which is read-only, read-and-write, or read-write-transactional is contemplated by data card 18.

Referring now to FIG. 2, fingerprint identification module 12 is shown in stand-alone condition, prior to connecting to any host device. FIM 12 includes slot 16 which is preferably along an edge 20 which is transverse to coupling portion 22 such that insertion of a data card 18 into slot 16 does not interfere with the coupling of FIM 12 to any host device. Generally, in a preferred embodiment, FIM 12 has a pager-like appearance, but may take any suitable form such that it may be easily connected with a host device. FIM 12 includes a top surface 22 which at one end is at least partially defined by a semi-parabolic ridge 24. Ridge 24 defines an inner wall 26 which extends to fingerprint read surface 28. At the center of read surface 28 is a fingerprint read field or fingerprint sensor 30, upon which the end user places a finger from which biometric information may be extracted. Wall 26 may take on shapes other than those specifically identified, namely the semiparabolic shape in the current embodiment. However, the shape of ridge 24 and wall 26 is important in that it exposes an area on the fingerprint read surface 28 such that a user may place a finger onto fingerprint sensor 30 while facing end 32, for example, while using the PDA or other host device 14 of FIG. 1. Alternatively, ridge 24 and wall 26 should also permit use of the fingerprint sensor 30 when the end user is faced 1800 from that position and is facing edge 34. The current shape of fingerprint read surface 28 as bounded by edge 26 and ridge 24 permits the user to place a finger for biometric sampling while facing edge 32 or while facing edge 34, without having to resort to unnecessary or undesirable bending of the hand to obtain the correct directional placement to produce a valid reading.

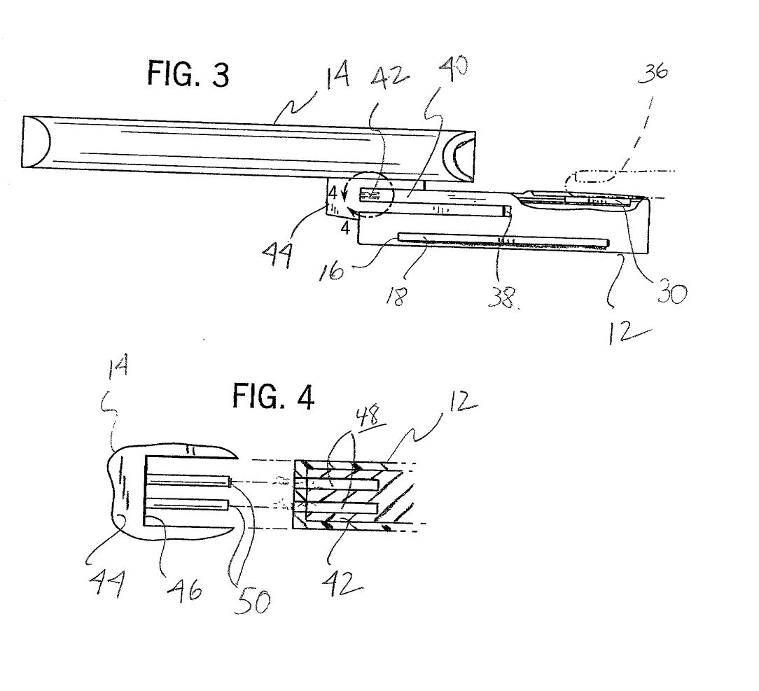

Referring now to FIG. 3, FIM 12 is shown connected to PDA host device 14. In a preferred use, data card 18 is inserted into slot 16 of FIM 12. The end user places a finger 36 in a conventional manner, to fingerprint sensor 30. FIM 12 includes a hollowed out portion 38 defining an extension connection arm 40, which terminates in a connector 42 for connection with connector portion 44, which extends downwardly from PDA 14.

Referring now to FIG. 4, the connection between FIM 12 and PDA 14 taken along line 4-4 of FIG. 3 is shown. Connection portion 44 includes a connection slot 46. In one embodiment, the connection slot 46 is a compact flash port or slot, which is a standard connection type on PDA devices, or a PCMCIA slot. The preferred connection is with the compact flash (CF) port in a serial connection. This serial communication port connection allows for the utilization of a standard OEM serial port stream driver that is provided as part of a standard operating system (Windows CE) to communicate with FIM 12. Connector 42 includes holes 48 that are receptive to compact flash pins 50 to create an electrical connection therebetween. In one embodiment, power is provided through the compact flash slot connector from the PDA or other pocket PC host to fingerprint identification module 12. This decreases the amount of battery power required by the FIM 12, in order to maintain a FIM that is lightweight and that presents the smallest possible footprint (width and length) as possible.

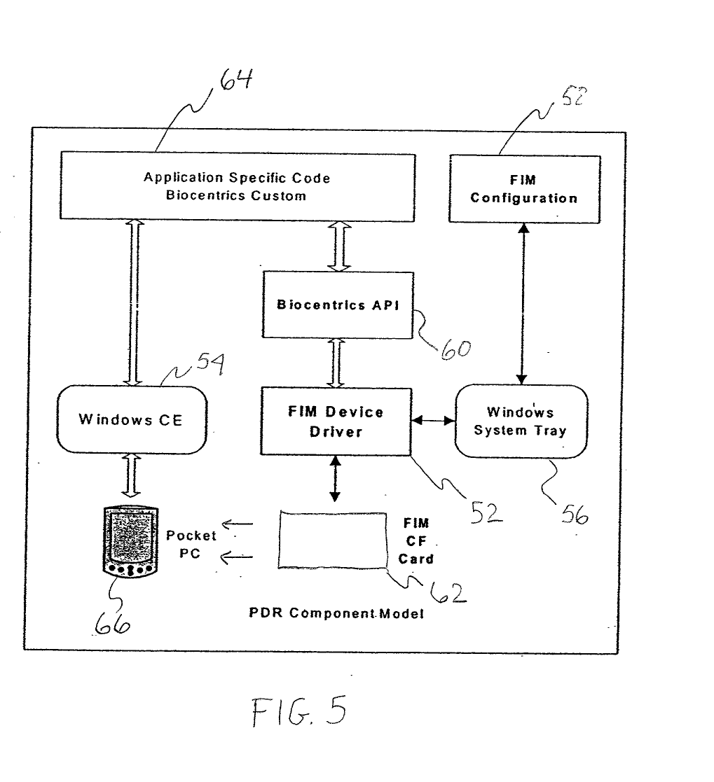

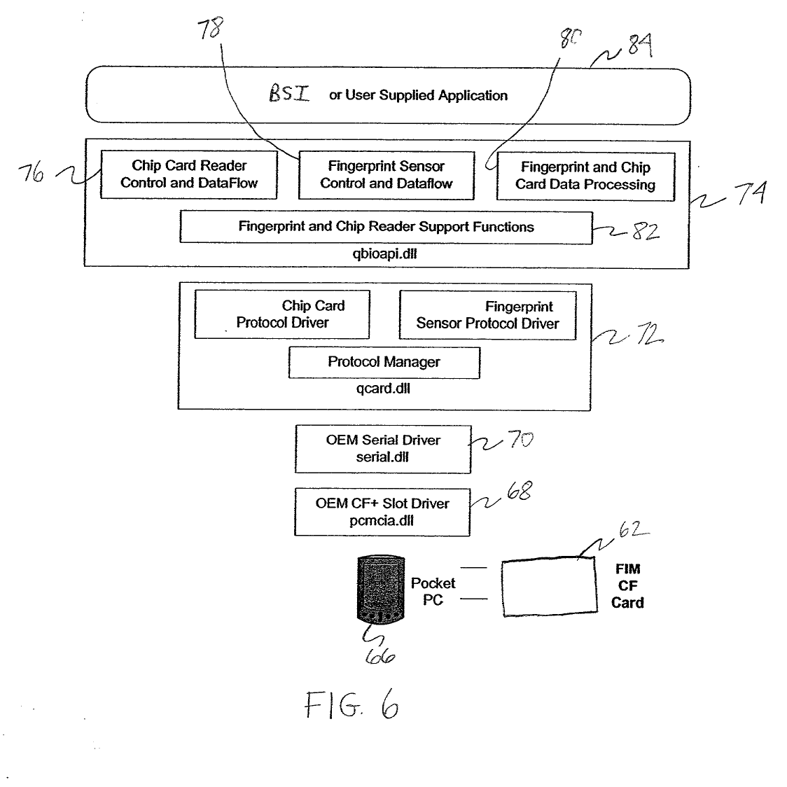

Referring now to FIG. 5, the functional layers for the software contemplated by the present invention are shown. Device driver 52 is a windows CE 54 level system component that controls the state and access to the components in the fingerprint identification module (12 of FIG. 1). It is contemplated that the device driver 52 preferably perform the following functionalities: Providing power and state management of the FIM components in order to maximize data flow, manage a compact flash slot controller; handle raw communications between the fingerprint reader, the data card reader and the PDA; provide the necessary program notification and attempt recovery in the case of fault conditions or exceptions; and present a graphical user interface to the user, via a system tray 56, that allows for configuration and tuning of the FIM components within FIM configuration 58.

Interfacing with FIM device driver 52 is application programming interface (API) 60. API 60 is a generalized instruction set that will expose the capabilities of the FIM to a developer of custom applications. API 60 is a portable interface that can be preferably ported to and compiled on any platform that offers a C compiler for development. This may include all Windows 9x, Windows CE, Geos and Palm operating system environments. Moreover, it is anticipated that any programming language that can make C type calls can be used to develop applications that utilize API 60. As contemplated by the present invention, the primary FIM functionality offered via the control will be notification of data card 62 insertion into the FIM, reading of the data card 62 data, providing a channel to the fingerprint reader to receive a data stream, extracting fingerprint minutia from the data, and comparing the extracted minutia to that stored data, which is retrieved from the data card 62. Under the umbrella of API 60 and FIM device driver 52 is application specific code 64. Application specific code 64 is programming code, preferably window CE, that is specific to the application and/or problem being addressed by the biometric solution system. It includes any user interface code, and any business logic that is necessary to reside in PDA or pocket PC 66. The code 64 also supports any data storage and transmission to a host PC, for example. Such code could be available off the shelf, such as a standard chip card enrollment program, a simple custom application that resides only in the portable biometric reader, or third-party integrators could use the API 60 to construct customized or commercial applications.

Referring now to FIG. 6, a process stack is shown to be used by the preferred software of the present invention. At the basic operational level, data card 62 is insertable into FIM 12 of FIG. 2, which is insertable into PDA 66. Operating the slot into which data card 62 will enter is slot driver 68 which will communicate via serial driver 70 to the rest of the FIM 12. The fingerprint sensor protocol driver, the chip, or data card protocol driver and the protocol manager are part of control protocol 72. All data card and fingerprint reader commands and data transmissions that occur between the FIM and the application software are converted into function calls into a serial data stream (or protocol), which represents a command to the FIM. The FIM will respond with the register values or data stream corresponding with the demand request. Control protocol 72 consists of a series of register level commands that are proceeded by a command header, which signifies whether the fingerprint sensor or the data card reader is a recipient of the command. Once the command is received, the commanded device will respond with the requested data. This architecture allows the driver to know when it will be receiving data, and the type of data it is receiving. Following the control protocol, the application programming interface 74 includes all those functions related to data card reader control and data flow 76, fingerprint sensor control and data flow 78, fingerprint and data card processing 80, as well as fingerprint and data card support function 82. By way of example, the following functions are preferred in the API 74 of the present invention.

Fingerprint Sensor Control and Dataflow 78

Fingerprint Sensor Control and Dataflow 78 includes the following functions:

int FingerprintNotify (int *(pcallback))

Function registers a user specified function with the BioAPI. The registered function will be called back when the fingerprint sensor senses the application of a finger to the sensor. The user specifies the function process.

Parameters

int*(pcallback) the function that will be called when a finger is applied to the sensor.

Return

0—if the function is registered

1—if the registration fails.

int FingerprintDetect ( )

Function will determine if a finger is currently on the sensor awaiting a read. This function can be used instead of the FingerprintNotify( ) process, but requires that the user application regularly poll (call) this function to detect the sensor state change.

Parameters

None

Return

0—the sensor is clear.

1—the sensor has a finger on it awaiting a read.

int FingerprintRead (char* *ppfpdata)

This function will power up the fingerprint sensor, which will then come up to speed to idle/detect, settle and read the data from the sensor. The QBioAPI.dll will allocate a buffer for the data and fill it with the fingerprint data from the sensor. The address of that buffer (the memory handle) will be returned in the ppfpdata variable at the address passed by the caller.

Parameters

char**ppfpdata the address of a char pointer which will contain the address of the returned raw fingerprint data buffer.

Return

0—if read was successful.

Non-zero—the error code of the failure.

Int Fingerprint Verify (char *pfpdata)

Function will perform a performance and fidelity check on the fingerprint data to verify its quality, and provide performance-tuning information back through to the sensor in preparation for subsequent reads.

Parameters

char *pfpdata the address of the data buffer containing the raw fingerprint data.

Return

0—verification successful. Good fingerprint image.

Non-zero—fault exists in the data, or another read is required to improve image.

Fingerprint and Data Card Processing Operations 80

Fingerprint and Data Card Processing Operations 80 includes the following functions:

int FingerprintExtract (char *pfpdata, struct **pfpminutia)

This function will extract the minutia records from the passed fingerprint data, and return them in a data structure allocated by the QBioAPI.dll. The address of that structure will be returned in the pfpminutia variable at the address passed by the caller.

Parameters

char *pfpdata the address of the data buffer containing the raw fingerprint data.

struct **ppfpminutia the address of a struct pointer which will contain the address of the returned fingerprint minutia.

Return

0—if minutia extraction was successful.

Non-zero—if the quality or quantity of minutia was insufficient.

intFingerprint2bmp (char *pfpdata, char **pbmpdata)

Function will copy the fingerprint data at the buffer address passed into another buffer that is of the format of a device independent bitmap file (.bmp).

Parameters

char *pfpdata the address of the data buffer containing the raw fingerprint data.

char *pbmpdata the address of a byte pointer which will contain the address of the returned. bmp file format.

Return

0—if data formatted correctly.

Non-zero if unable to format the fingerprint data at the passed buffer address.

int FingerprintMatch (struct *pfpminutia, struct *pcardminutia, int nNumMinutia)

Function will attempt to match the passed fingerprint minutia data with the passed minutia data from the chip card or other source.

Parameters

struct *pfpminutia the address of the structure buffer containing the minutia generated from the fingerprint data.

struct *pcardminutia the address of the struct buffer containing the minutia read from the chip card.

Int nNumMinutia the number of minutia data sets (fingerprints) present in the cardminutia structure.

Return

0—if the matching algorithms determine a match based on the matching sensitivity and selectivity settings.

1—if unable to achieve a match.

Chip Card Reader Control and Dataflow 76

Chip Card Reader Control and Dataflow 76 includes the following functions:

int CardNotify (int *(pcallback))

Function will register the passed function with the QBioAPI. This registered function will be called when a chip card is inserted into the card reader. Information describing the chip card will be passed to this function from the API.

Parameters

Int *(pcallback) the function to be registered.

For callback function:

int *cardtype

int *memsize

int *memavail

Return

0—if the function is registered

1—if the registration fails.

int CardDetect (int *cardtype, int *memsize, int *memavail)

Function will determine if a chip card is currently inserted in the card reader. This function can be used instead of the CardNotify() process, but requires that the user application regularly poll (call) this function to detect the card reader state change.

Parameters

int *cardtype the type of chip card present in the card reader.

int *memsize the total storage size a card of the type in the reader.

int *memavail the amount of that total storage that is current available.

Return

0—the card reader is empty.

1—the card reader has a card inserted.

int CardRead (str *pfileID, char **ppcarddata, long seek, long readbytes)

Function causes the data to be read from the chip card, and return it in a data buffer allocated by the QBioAPI.dll. The address of that data will be returned in the pcarddata variable at the address passed by the caller.

FileID specifies the file to be read on the card. This is a full service Open-Read-Close function, so no file handle is required. In the case of a memory card, the FileID is ignored, and the seek will be translated into the card address to begin the read.

This function does not perform validation or integrity checking of the card data. It is a simple read function that can be used for any type data. To validate the header of a Combi format card, call this function first, then call CardCombiType( ).

Parameters

str *pfileID a pointer to a string containing the ID of a file on a smart card. If the current card is a memory card, this field is ignored and should be a null pointer.

char **ppcarddata the address of a char pointer which will contain the address of the returned raw card data buffer.

long seek the number of byte to seek (the offset) before beginning a read operation. On a smart card, this is the number of bytes in a file. On a memory card, this translates to the base address+offset of the card.

long *preadbytes on the call, number of bytes to read from the card. On the return, the number of bytes actually read.

Return

0—if the read was successful. The number of bytes read is stored in readbytes, and should be the same as the called value.

Non-zero—the call failed. The value represents the failure code. If a partial read occurred, the number of bytes actually read is returned in readbytes, and the partial read data buffer is returned in pcarddata.

Int CardCombiType (char *pcarddata, int *pnNumminutia)

This function will perform a verification, unpack, and fidelity check operations on the data in at the passed address, in order to validate that it is a from a card of Combi format. The carddata buffer must contain the entire Combi card data set, including the minutia table. It is assumed that the user has performed a data read operation to store the Combi type chip card data in a buffer before this call is made.

Parameters

char *pcarddata the address of the data buffer that contains the entire data set read from the Combi type chip card.

Int * pnNumminutia the address of an integer in which the number of minutia data sets (fingerprint) that are stored on the card is returned.

Returns

0—data in buffer is authenticated as Combi compliant.

I—the data in the buffer is not Combi compliant.

Int Card Write (str *pfilelD, char *pcarddata, long seek, long writebytes)

Function will cause the card data to be written to the card. If a smart card and fileID does not exist, it will be created. Same considerations for memory card type as CardRead( ).

Parameters

str *pfilelD a pointer to a string containing the ID of a file on a smart card. If the current card is a memory card, this field is ignored and should be a null pointer.

char *ppcarddata a char pointer which contains the address of the card data buffer.

long seek the number of bytes to seek (the offset) before beginning a write operation. On a smart card, this is the number of bytes to seek in a file. On a memory card, this translates to the base address+offset of the card.

long *pwritebytes on the call, number of bytes to write to the card. On the return, the number of bytes actually written.

Return

0—if the write was successful. The number of bytes written is stored in writebytes, and should be the same as the called value.

Non-zero—the call failed. The value represents the failure code. If a partial write occurred, the number of bytes actually written is returned in writebytes.

BioAPI Support Functions 82

int ByteRead (char *pdata, long offset, void *preaddata, char numbytes)

This function will read the contents of a carddata or fingerprint buffer one byte at a time for numbytes. Primarily for use in a Visual Basic development environment, this function allows for binary data stored in the buffer pdata to be read and stored in a Visual Basic data type or array.

Parameters

char *pdata a pointer to a buffer containing chip card or fingerprint data.

long offset the number of bytes to offset in the buffer to begin the read.

char *preaddata a pointer to a variable of the proper type to receive the data.

char numbytes number of bytes to return to preaddata. See data type table below.

Return

0—read successful.

int Byte Write (char *pdata, long offset, void *pwritedata, char numbytes)

This function will read the contents of a carddata or fingerprint buffer one byte at a time for numbytes. Primarily for use in a Visual Basic development environment, this function allows for binary data stored in the buffer pdata to be read and stored in a Visual Basic data type or array.

Parameters

char *pdata a pointer to a buffer containing chip card or fingerprint data.

long offset the number of bytes to offset in the buffer to begin the write.

char *pwritedata a pointer to a variable of the proper type to source the data.

char numbytes number of bytes to return starting at pwritebuff. See data type table below.

Return

0—read successful.

| VBCE data type (variants) | Numbytes |
|---|---|
| Byte | 1 |
| Integer | 2 |
| Long | 4 |
| String | Not to exceed existing size of string |

int ReleaseBuffer (char *pdata)

int ReleaseBuffer (char *pdata)

Function will release back to the system memory pool the memory that was allocated by the QBioAPI to hold either fingerprint or chip card data buffer or structure. This call should be made when an application no longer has need of the data, in order to conserve system resources.

Parameter

char *pdata a pointer to a chip card of fingerprint data buffer or structure.

Return

0—memory has been released.

1—memory could not be released.

int CardDir (int firstrec, char *pdirdata)

Function will return the records of the card file system directory, one record per call until they are exhausted. Set firstrec to 1 to begin at the top of the directory.

Parameters

int firstrec set to 1 for first read, 0 for subsequent reads.

char * pdirdata a pointer to a string buffer of sufficient size to hold a directory record.

Return

0—directory entry returned.

Non-zero—directory exhausted or error.

int CardDel (str *fileID)

Function will delete the specified file from a smart card file system.

Parameters

Str *fileId a string identifying the file to delete.

Return

0—file was successfully deleted.

Non-zero—fault in deleting the file.

Finally, user supplied or third party supplied applications 84 are processed in any preferred embodiment of the present invention.

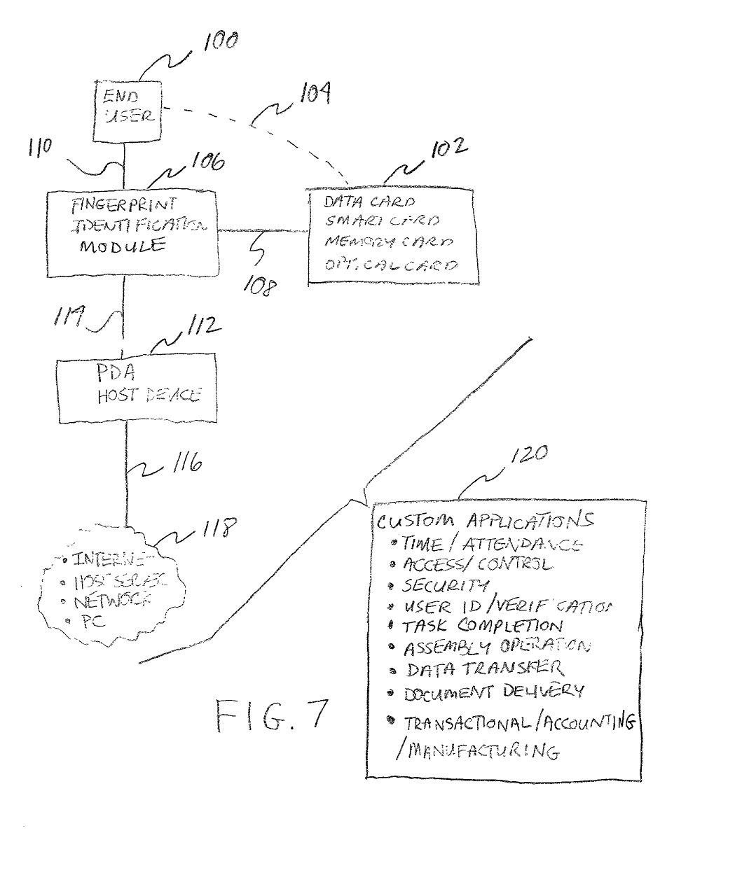

Referring now to FIG. 7, a schematic representation of a biometric system in accordance with the present invention is shown as part of what is described as a biometrics anywhere initiative. In the system, an end user 100 goes through the process of enrollment, or the process of collecting biometric samples from a person such that the layer can be compared to a live biometric sample of the end user 100. Such data is stored on a data card 102, which may take many forms, including a smart card capable of reading, writing and computational capabilities, a memory card having read/write capabilities or an optical card having read only data such as a 2-dimensional bar code encoding fingerprint data. In many cases, end user 100 may be in possession of the data card 102. However, it is contemplated by the present invention that the data card may reside at a particular location, with other data cards of similarly enrolled end users such as an end user 100. Given a particular application, it may be desired that the end user maintain possession of data card 102. Regardless, data card 102 represents stored biometric information of end user 100 and therefore there is a biometric link 104 between data card 102 and end user 100. In the present invention, fingerprint identification module 106 receives information stored on data card 102 through connection 108 (for example, by directly reading the data card 102). Alternatively, information contained on data card 102 may be preprogrammed into fingerprint identification module 106, thereby eliminating the need to have a data card available during identification or verification of end user 100. Also, information contained on data card 102 may be wirelessly transmitted via connection 108 to fingerprint identification module 106, for example, by the use of RF ID technology and proximity reading of data card 102 where the actual card need not necessarily be inserted directly into the fingerprint identification module 106 in order to be read. End user 100 provides a live biometric sample 110 to be read by fingerprint identification module 106. Extraction then occurs, which is the process of converting the captured biometric sample into biometric data so that it can be compared to the data on data card 102. Fingerprint identification module 106 works with PDA or other host device 112 via connection 114, such that the occurrence of a match or non- match will allow PDA 112 to perform custom specific functionalities. Such information may be transferred via wireless connection 116 to a network 118, that may include the internet, a host server which may be part of a network or simply a resident PC. As noted, biometrics solutions possible with the above components may be fashioned into various custom applications 120, and such varying arrangements, as well as replication of the above model in a wide system may be utilized to effect such customized applications. For example, applications which require time and attendance records may be appropriate. Other custom applications 120 include access and control of facilities as well as security measures to prevent unauthorized entrance. There may be applications 120 that include simple user identification and verification to generate a record of those passing into a given situation, such as a classroom etc. Additionally, other custom applications 120 may include the completion of a task, where a record may be sent by PDA host device 112 when a given task has been satisfied, such as an assembly operation, a transfer of data, or delivery of an electronic document. The transfer of data from PDA 112 may include other transactional, accounting, manufacturing or other data that is desired to be transmitted at particular times and by particular personnel. Contemplated applications may include: transportation—verification of receipt of goods, and checking of manifest for items delivered; education—identification of students and school personnel anywhere, matching of children and their caregivers when students are leaving school, verifying identity of test-takers in educational settings; aviation—verification of aircraft power plant or airframe repairs, identification of personnel for controlled access, secure luggage pickup and delivery; healthcare—providing proper administration of the correct pharmaceutical to the correct patient in a hospital or clinic setting, and registration of personnel who have access to controlled substances; and banking—tellers may have proof sheet on a PDA, to which is recorded the value of securities they started the day with, the total amount of new securities they took in or paid, and obtain an end of day balance, digitally signed with a fingerprint. The custom applications may be utilized wherever there is a desire for a biometric digital signature, to create a “biometrics anywhere” solution.

The present invention has been described in terms of the preferred embodiment, and it is recognized that equivalents, alternatives, and modifications, aside from those expressly stated, are possible and within the scope of the appending claims.

1. A biometric device comprising:
a fingerprint module having a fingerprint sensor for reading a fingerprint and generating fingerprint data; and
electronic circuitry located within the fingerprint module and connected to the fingerprint sensor to process the fingerprint data.

2. A biometric device comprising:
a fingerprint module having a fingerprint sensor for reading a fingerprint and generating fingerprint data; and
electronic circuitry located within the fingerprint module and connected to the fingerprint sensor to process the fingerprint data;
wherein the fingerprint module further includes a compact flash connection slot.

3. A biometric device comprising:
a fingerprint module having a fingerprint sensor for reading a fingerprint and generating fingerprint data; and
electronic circuitry located within the fingerprint module and connected to the fingerprint sensor to process the fingerprint data;
wherein the fingerprint module further includes a smart card slot for receiving a smart card.

4. A biometric device comprising:
a fingerprint module having a fingerprint sensor for reading a fingerprint and generating fingerprint data; and
electronic circuitry located within the fingerprint module and connected to the fingerprint sensor to process the fingerprint data;
wherein the fingerprint module further includes a compact flash connection slot for connecting the fingerprint module and a smart card slot for receiving a smart card.

5. A biometric device for use with a personal digital assistant (PDA) and a user of the PDA comprising:
a fingerprint module including a fingerprint sensor for reading a fingerprint of the user, the fingerprint module receptive to and connectable with the PDA to allow electronic communication with the PDA, wherein the fingerprint module includes a portion adapted to receive and read a data card having fingerprint information, and wherein the fingerprint module is capable of determining a match between the user fingerprint read from the fingerprint sensor and the fingerprint information on the data card.

6. The biometric device of claim 5 wherein the data card is one of a smart card, a memory card and an optical card having an optical bar code for storing the fingerprint information.

7. The biometric device of claim 5 wherein the fingerprint information is stored on a chip located on the data card.

8. The biometric device of claim 5 wherein the PDA is one of a personal computer and a wireless phone with PDA capabilities

9. The biometric device of claim 5 wherein determination of the match between the user fingerprint and the fingerprint information on the data card enables biometric identification or verification of the user of the PDA.

10. The biometric device of claim 5 wherein the biometric device generates user information, the user information selected from the group consisting of user entry time, user exit time, user check-in time and user attendance.

11. The biometric device of claim 5 wherein the biometric device generates information to selectively grant the user access to a desired location or control of a desired device.

12. The biometric device of claim 5 wherein the biometric device further generates information to identify or verify an identity of the user.

13. A biometric system comprising:
a personal digital assistant (PDA) having at least one application therefor;
a fingerprint module interconnected with the PDA such that the fingerprint module may be utilized in conjunction with the PDA to provide a biometric solution for the at least one application.

14. A fingerprint module for use in a biometric authentication system, the fingerprint module including a fingerprint sensor and wherein the fingerprint module is capable of connection to and operation with a personal digital assistant as part of the biometric authentication system.

15. A portable biometric reader for use with a processing host comprising:
a fingerprint module having a communication port for communication with the processing host, the fingerprint module including a fingerprint sensor for reading a fingerprint of the user, the fingerprint module receptive to and connectable with the processing host to allow electronic communication with the processing host, wherein the fingerprint module includes a portion adapted to receive and read a data card having fingerprint information, and wherein the fingerprint module is capable of determining a match between the user fingerprint read from the fingerprint sensor and the fingerprint information on the data card.

16. The portable biometric reader of claim 15 wherein the portable biometric reader is capable of utilizing any communication capabilities of the processing host.

17. A biometric device for use with a personal digital assistant (PDA) comprising:
a biometric module adapted for communication to the PDA, and wherein the biometric module includes an application programming interface software that can be customized to run at least one application for the PDA.

18. A biometric identification module comprising:
a housing;
a biometric sensor exposed through the housing for obtaining user biometric data;
a receiving portion receptive to a biometric data storage device having stored biometric data;
electronic processing and storage circuitry disposed within the housing and connected to the biometric sensor; and
an application program interface programmed into the processing and storage circuitry to compare the user biometric data to the stored biometric data.

19. The biometric identification module of claim 18, wherein the application program interface is compatible with additional programming to obtain application specific output and functionalities for the biometric identification module.

20. The biometric identification module of claim 18, wherein the stored biometric data and the user biometric data are fingerprint data.

21. A biometric solution system for use with a portable host device comprising:
a biometric identification module comprising:
a housing; and
a biometric sensor exposed through an outer surface of the housing;
a biometric data storage media, the housing further including a receiving portion receptive to the biometric data storage media; and
an application protocol interface programmed into the module, wherein the application protocol interface is capable of being used in conjunction with an application specific software to provide a customized biometric application solution useable with the portable host device.

22. The biometric solution system of claim 21, wherein the biometric data storage media is one of a memory card, a smart card and an optical data card.

23. A biometric system comprising:
a fingerprinted identification module for extracting fingerprint data having a communication port; and
a host device connected to the fingerprint identification module through the communication port, the host device having a storage capacity and processing power to manipulate the fingerprint data extracted from the fingerprint identification module.

24. The biometric system of claim 23 wherein the communication port between the fingerprint identification module and the host device is a serial connection.

25. The biometric system of claim 24 wherein the serial connection is through a compact flash port.

26. The biometric system of claim 23 wherein the serial connection is through a PCMCIA port.

27. The biometric system of claim 20, further comprising a biometric data card insertable into the fingerprint identification module for comparison to data extracted by the fingerprint.

28. A biometric solution system for use with a portable host device comprising:
a module for receiving biometric samples, the module connected to the portable host device;
a storage media having stored biometric data, the storage media insertable into the module; and
an application program for use by the portable host device wherein the application program is specifically designed to operate for a particular biometric solution, the module in operative association with the application program such that a comparison may be made between the biometric samples and the stored biometric data, and wherein the comparison generates an output specific to the application program which may be displayed and transmitted by the portable host device as part of the biometric solution.

29. The biometric solution system of claim 28, further including an internet server in electronic communication with the portable solution system for communication to a central data center.

30. The biometric solution system of claim 28, wherein the portable host device is electronically connected to one of a PC, a host server, and a network for collection and storage of the application program output.

31. The biometric solution system of claim 28, wherein the biometric samples are fingerprints.

32. A biometric network comprising:
a plurality of biometric devices, each biometric device comprising:
a fingerprint module including a fingerprint sensor for reading a user fingerprint placed onto the fingerprint sensor, wherein the fingerprint module includes a portion adapted to receive and read a data card having electronic fingerprint information, and wherein the fingerprint module is capable of determining a match between the user fingerprint read from the fingerprint sensor and the electronic fingerprint information; and
a server having a connection to each of the plurality of biometric devices to receive data from each of the plurality of biometric devices.

33. The biometric network of claim 32 wherein the server is connected to the internet.

34. The biometric network of claim 32 wherein the connection is wireless.

35. A biometric device comprising:
a fingerprint module;
a fingerprint sensor connected to the fingerprint module for generating fingerprint data;
a communication port integral with the fingerprint module in electrical communication with the fingerprint sensor for transmitting the fingerprint data from the fingerprint sensor through the communication port.

36. The biometric device of claim 35 wherein the fingerprint module further includes a slot for receiving a smart card.
